(19) United States
(12) Patent Application Publication
(10) Pub. No.: US 2018/0278979 A1
(43) Pub. Date: Sep. 27, 2018

(54) OPTIMIZATION OF MEDIA PRESENTATIONS

(71) Applicant: THOMSON Licensing, Issy-les-Moulineaux (FR)

(72) Inventors: Samir AHMED, Culver City, CA (US); Christophe LOUVION, LOS ANGELES, CA (US)

(21) Appl. No.: 15/764,386

(22) PCT Filed: Sep. 30, 2015
(86) PCT No.: PCT/US2015/053263

§ 371 Date: Mar. 29, 2018

(51) Int. Cl. H04N 21/2662; H04N 21/658

(52) U.S. Cl. CPC H04N 21/2662; H04N 21/658

(57) ABSTRACT

A method that optimizes multimedia content for transmission is described. The method includes: calculating (320) an available bandwidth associated with a transmission path from a source device to a destination device; retrieving (330) a multimedia content item; optimizing (360) the multimedia content item for transmission over the available bandwidth; and collecting (380) feedback associated with presentation of the multimedia content item. A server that optimizes multimedia content for transmission includes: a processor for executing sets of instructions; and a non-transitory medium that stores the sets of instructions. The sets of instructions include: calculating (320) an available bandwidth associated with a transmission path from a source device to a destination device; retrieving (330) a multimedia content item; optimizing (360) the multimedia content item for transmission over the available bandwidth; and collecting (380) feedback associated with presentation of the multimedia content item.

### BACKGROUND

Multimedia content is consumed across various communication networks. Such networks may provide limited bandwidth to users. Such limited bandwidth may cause users to encounter problems with multimedia presentation and/or may limit the number of users able to be supported at a given time.

Thus there is a need for a scalable way to allocate network bandwidth usage for multimedia presentation while maintaining user satisfaction.

### SUMMARY

A method that optimizes multimedia content for transmission is described. The method includes calculating an available bandwidth associated with a transmission path from a source device to a destination device; retrieving a multimedia content item, optimizing the multimedia content item for transmission over the available bandwidth, and collecting feedback associated with presentation of the multimedia content item. A server that optimizes multimedia content for transmission includes a processor for executing sets of instructions, and a non-transitory medium that stores the sets of instructions. The sets of instructions include calculating an available bandwidth associated with a transmission path from a source device to a destination device, retrieving a multimedia content item, optimizing the multimedia content item for transmission over the available bandwidth, and collecting feedback associated with presentation of the multimedia content item.

Some embodiments provide ways to allocate bandwidth across multiple network-connected playback devices. Bandwidth may be allocated in various ways (e.g., based on total available bandwidth, number of active users, etc.) and/or based on various parameters (e.g., user connection speed, media type, etc.).

In some embodiments, optimized multimedia content is associated with the allocated bandwidth. Such optimization may allow the content to be provided within the confines of the allocated bandwidth. The content may be optimized by adjusting various attributes (e.g., frame rate, color depth, resolution, etc.). The content optimization may be dynamically adjusted based on various relevant factors (e.g., changing network conditions, user feedback, etc.).

Some embodiments collect user feedback. The user feedback may be analyzed and used to modify the adjustments of the various attributes. Such user feedback may be applied on an individual level (e.g., a specific user may receive multimedia content with attributes that satisfy the specific user), on a group level (e.g., users may be associated based on various criteria and the cumulative feedback may be used to update the attribute adjustment for the group), and/or on a population level (e.g., all user feedback may be analyzed to generate a default set of adjustment attributes).

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a hardware system according to an exemplary embodiment;

FIG. 2 illustrates a schematic block diagram of an exemplary distribution system of some embodiments;

FIG. 3 illustrates a flow chart of an exemplary process of some embodiments that provides optimized content;

FIG. 4 illustrates a flow chart of an exemplary process of some embodiments that utilizes user feedback to improve optimization of content; and

FIG. 5 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to allocate bandwidth and optimize content for playback.

A first exemplary embodiment provides a method that optimizes multimedia content for transmission. The method includes calculating an available bandwidth associated with a transmission path from a source device to a destination device; retrieving a multimedia content item; optimizing the multimedia content item for transmission over the available bandwidth, and collecting feedback associated with presentation of the multimedia content item.

A second exemplary embodiment provides a server that optimizes multimedia content for transmission. The server includes a processor for executing sets of instructions, and a non-transitory medium that stores the sets of instructions. The sets of instructions includes calculating an available bandwidth associated with a transmission path from a source device to a destination device, retrieving a multimedia content item, optimizing the multimedia content item for transmission over the available bandwidth, and collecting feedback associated with presentation of the multimedia content item.

A third exemplary embodiment provides a method that adjusts content optimization and transmission based on user feedback. The method includes providing an optimized content item to at least one destination device, receiving feedback from the at least one destination device; analyzing the received feedback, and updating at least one optimization parameter from among a set of optimization parameters based on the received feedback.

A fourth exemplary embodiment provides a server that adjusts content optimization and transmission based on user feedback. The server includes a processor for executing sets of instructions, and a non-transitory medium that stores the sets of instructions. The sets of instructions include providing an optimized content item to at least one destination device, receiving feedback from the at least one destination device, analyzing the received feedback, and updating at least one optimization parameter from among a set of optimization parameters based on the received feedback.

Several more detailed embodiments are described in the sections below. Section I provides a description of various exemplary hardware systems used by some embodiments. Section II then describes exemplary methods of operation of some embodiments. Lastly, Section III describes a computer system which implements some of the embodiments.

### I. Hardware System

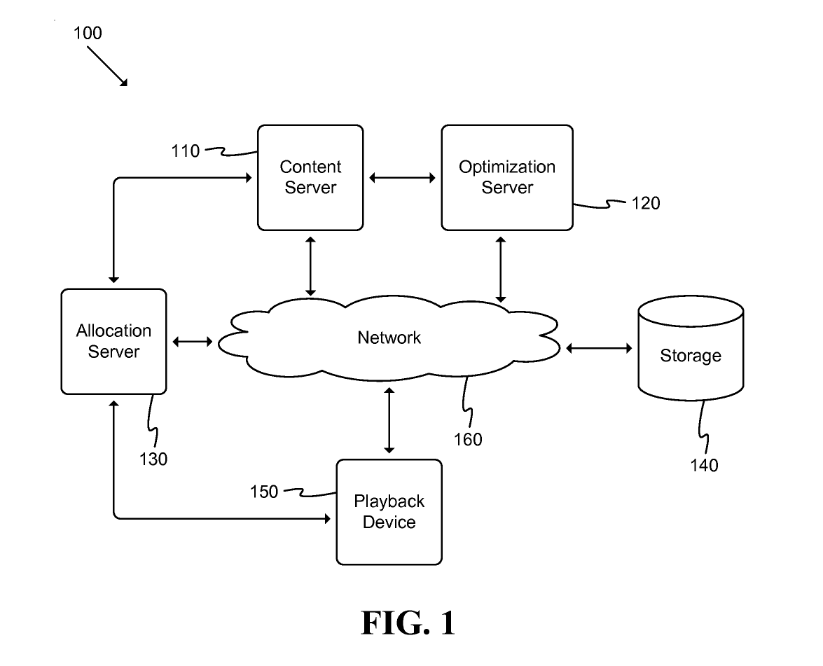

FIG. 1 illustrates a schematic block diagram of a hardware system 100 according to an exemplary embodiment. As shown, the system may include a content server 110, an optimization server 120, an allocation server 130, a storage 140, a playback device 150, and a network 160.

The content server 110 may include one or more physical devices able to execute instructions and/or process data. The content server may transmit various content items over network 150 to one or more devices 140.

The optimization server 120 may include one or more physical devices similar to the content server 110. The content server and the optimization server 120 may be provided by a single device (and/or associated set of devices). In some embodiments, the optimization server 120 may receive content from the content server 110 over a local connection or network connection. The optimization server 120 may optimize content for distribution and may provide the content to the various playback devices 150. Alternatively, the optimized content may be sent to the content server 110 for distribution.

The allocation server 130 may include one or more physical devices similar to the content server 110 or optimization server 120. The optimization server, the content server 110, and the allocation server 130 may be provided by a single device (and/or associated set of devices). The allocation server may allocate bandwidth to the various playback devices 150 and/or to the various content servers 110. Such allocation may be performed in conjunction with various network-connected resources (e.g., a service provider server, a content access application programming interface (API), etc.). Bandwidth allocation may be communicated to various appropriate resources (e.g., playback devices, content servers, service providers, etc.).

The allocation server 130, optimization server 120, and/or content server 110 may further allocate bandwidth by modifying or optimizing the multimedia content such that the content is able to be supplied within the confines of the bandwidth allocation. The allocation server 130 of some embodiments may provide various parameters or attributes to the optimization server 120 such that the multimedia transmission requirements match the allocated bandwidth.

The storage(s) 140 may be accessible to one or more system components locally or via one or more networks 160. Each storage 140 may store and communicate information including data and instructions.

Each playback device 150 may be capable of multimedia playback over one or more networks. Example devices include smartphones, tablets, personal computers, televisions, and wearable devices, among others.

The network(s) 160 may include various types of networks (e.g., wired networks, wireless networks, cellular networks, the Internet, etc.) with the network communication pathways including various devices and device types.

During operation, a user may select some content for playback on device 150. The device may send a request to content server 110. The content server may interact with the allocation server 130 to determine a transmission bandwidth (or “transmission usage bandwidth”). The content server 110 may then send the content to the optimization server 120 for optimization based on the allocated bandwidth and/or other relevant factors. The optimization server may supply the optimized content to the playback device 150.

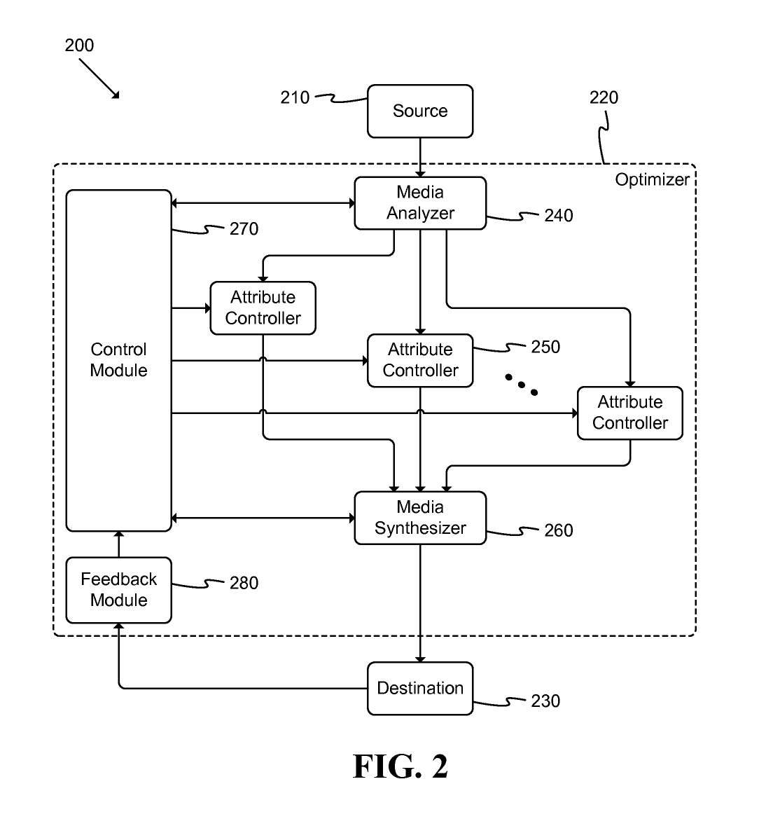

FIG. 2 illustrates a schematic block diagram of an exemplary distribution system 200 of some embodiments. Specifically, this figure shows an exemplary content optimization path. As shown, the system 200 may include a source 210, an optimizer 220, and a destination 230.

The source 210 may be a device such as content server 110 described above, and/or any other sources of multimedia content. The optimizer 220 may be implemented using a device such as optimization server 120 described above. The destination 230 may include devices such as playback device 140, content server 110, etc.

The optimizer 220 may include a media analyzer 240, a set of attribute controllers 250, a media synthesizer 260, a control module 270, and a feedback module 280.

The media analyzer 240 may analyze incoming content received from the source 210 in order to determine various relevant parameters associated with the content (e.g., file size, frame rate, resolution, color depth, etc.). In some embodiments, the media analyzer 240 may divide the content into various sub-elements (e.g., audio content, video content, etc.) for processing.

Each attribute controller 250 may modify the content based on a change to some attribute (e.g., frame rate, color depth, resolution, etc.). The attribute controllers may receive attribute values from the control module 270.

The media synthesizer 260 may receive the various sub-elements from the attribute controllers 250 and combine the sub-elements into a single multimedia content item suitable for delivery to the destination 230.

The control module 270 may control the operations of other system elements and may communicate with various internal and/or external components. The control module may receive bandwidth allocation information and generate attribute values for use by the attribute controllers 250. The attribute values may be based at least partly on information received from the media analyzer 240. Likewise, the attribute values may be based at least partly on information received from the source 210 or destination 230.

The feedback module 280 may receive user feedback via the destination device 230. The user feedback may include, for instance, a user satisfaction level with supplied content (e.g., a rating from one to five stars, a binary acceptable or not acceptable rating, etc.), user-specific preferences, etc. The feedback module 280 may collect, analyze, and apply such feedback to content optimization, as appropriate. The feedback module may supply such information to the control module 270 for use in defining attribute values or performing other functions.

During operation, the optimizer 220 may receive content from the source 210. In addition to the content, the optimizer 220 may receive information such as allocated bandwidth, user information, identity of the destination 230, etc. The optimizer 220 may continuously supply optimized content based on the current bandwidth allocation and/or other relevant factors such as user satisfaction. During or after consumption of the content, feedback may be received at the optimizer 220 from the destination 230. Such feedback may be used to modify current and/or future optimization of content.

One of ordinary skill in the art will recognize that systems 100 and 200 may be implemented in various different ways without departing from the scope of the disclosure. For instance, different embodiments may include multiple instances of each element or device. As another example, different embodiments may include additional elements and/or omit some elements. Furthermore, elements may be combined and/or divided in different embodiments.

### II. Methods of Operation

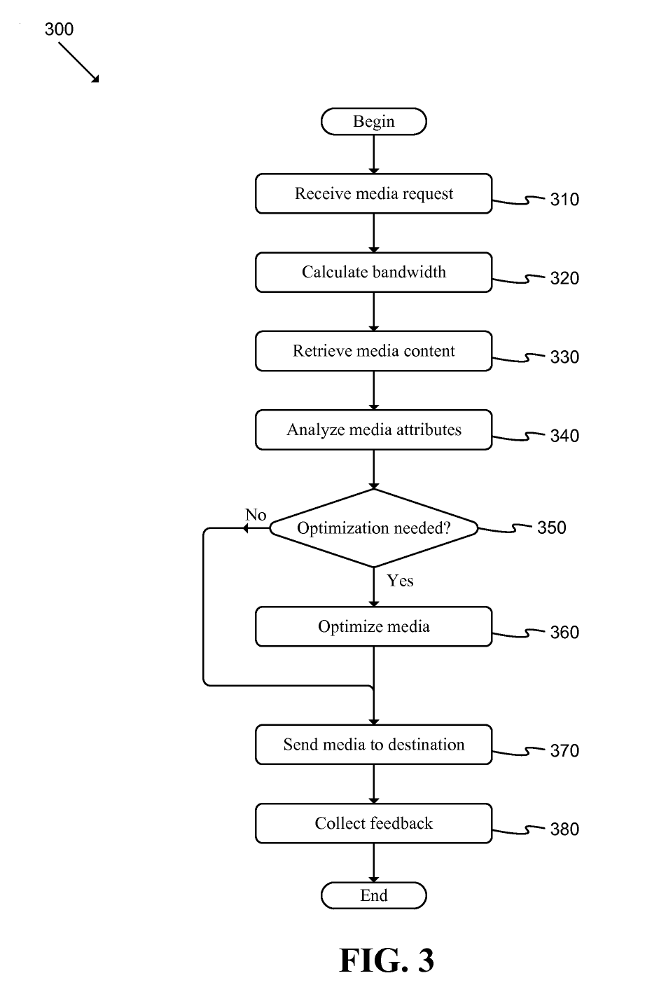

FIG. 3 illustrates a flow chart of an exemplary process 300 of some embodiments that provides optimized content. Such a process may be implemented by a server device and/or client device, such as a combination of servers 110-130, playback device 150, and/or optimizer 220 described above. The process may begin, for instance, when a user launches a media player, accesses a website with streaming content, etc.

As shown, the process may receive (at 310) a media request. Such a request may be made via an application or “app”, web page, and/or other appropriate paths. The request may be associated with a particular user device (and/or set of user devices) and may be received at the server.

Next, the process may calculate (at 320) available bandwidth. Such a calculation may be based on various relevant factors. Such factors may include, for instance, total bandwidth available to a content provider, number of active users, available bandwidth to a user device (and/or other applications that utilize or affect available bandwidth), data plan limitations, media type, etc. In some cases, the calculation may be retrieved from an external resource (e.g., estimated bandwidth may be retrieved from a service provider or other appropriate party).

The requested media is then is then retrieved (at 330) from the servers, such as content server 110, for analysis. This retrieval may be performed over the network 150.

The process may then analyze (at 340) the media attributes for the retrieved media. Such attributes may include, for instance, size, resolution, frame rate, audio quality, color depth, bit depth, bit rate, compression ratio, etc. As part of the analysis, the process may determine the bandwidth required to transmit the retrieved media.

Next, the process may determine (at 350) whether optimization of the media is needed. Such a determination may be made by comparing the available bandwidth to the required bandwidth (or other appropriate thresholds, such as a percentage of available bandwidth).

If the process determines (at 350) that optimization is needed, the process may then optimize (at 360) the media. Such media may be optimized in various appropriate ways. For instance, various attributes of the media may be modified or adjusted, such as the frame rate, resolution, color depth, etc. Some embodiments may include a look-up table or other appropriate data structure such that an appropriate transmission usage bandwidth may be determined based on the available bandwidth.

In addition, within the confines of the appropriate transmission usage bandwidth, the media may be optimized in various ways depending on various relevant factors. For instance, in a first example, a particular user may have an available bandwidth that is not sufficient for full-quality transmission of a selected media item. The media item may be optimized to satisfy the bandwidth limitations based at least partly on feedback received from the user (whether past feedback or current feedback). For instance, the particular user may be dissatisfied with videos lacking color depth but be less sensitive to frame rate variations.

As another example, the optimization may be at least partly based on the type of content and/or feedback received from other users and associated with the content item. For instance, viewers of video associated with a sporting event may be sensitive to frame rate variations, but relatively unaffected by variations in color depth. Each content item may be associated with feedback indicating desired adjustment levels associated with multiple viewers of each particular content item.

As still another example, the optimization may be at least partly based on information regarding the playback device. For instance, users viewing a handheld device may indicate different preferences than users viewing a large monitor or television.

After determining (at 350) that no optimization is needed, or after optimizing (at 360) the media, the process may send (at 370) the media to the destination. The media may be sent across various appropriate communication pathways.

Next, the process may collect (at 380) feedback and then may end. Such feedback may be collected and applied during media playback. Some embodiments may analyze and apply the feedback to future viewing sessions, where the feedback may be associated with the particular viewer, the particular content item, device type, user demographic information, etc.

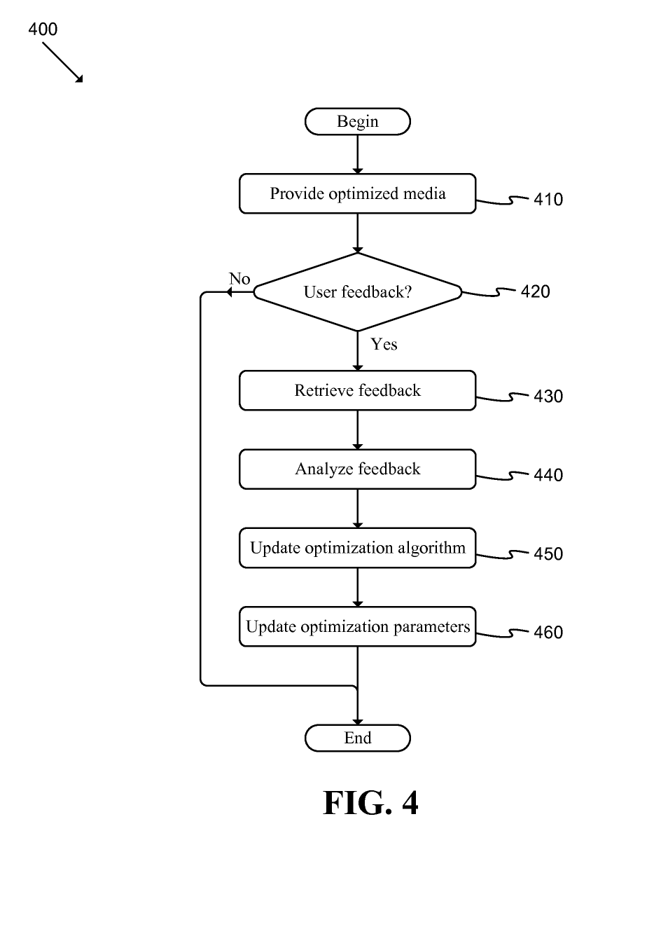

FIG. 4 illustrates a flow chart of an exemplary process 400 of some embodiments that utilizes user feedback to improve optimization of content. Such a process may be implemented by a server device and/or client device, such as a combination of servers 110-130, playback device 150, and/or optimizer 220 described above. The process may begin, for instance, when optimized media of some embodiments is delivered to a user.

As shown, the process may provide (at 410) optimized media to a destination. The media may be provided using a process similar to process 300. Next, process 400 may determine (at 420) whether user feedback is available. Such feedback may be provided by a user in real time (e.g., by indicating that current playback is unacceptable) and/or after viewing some media (e.g., by completing a survey or otherwise indicating satisfaction). Such feedback may be collected and analyzed as each feedback response or indication becomes available, or after a feedback threshold has been exceeded (e.g., number of users providing feedback since a last update or analysis). In some embodiments, feedback responses may include lack of response or action (e.g., if a user consumes an entire media item without complaint, the user may be assumed to have been satisfied with the presentation parameters).

If the process determines (at 420) that no user feedback is available, the process may end.

If the process determines (at 420) that user feedback is available, the process may then retrieve (at 430) the feedback. Such feedback may be retrieved from an appropriate storage or other resource.

Next, the process may analyze (at 440) the retrieved feedback. Such analysis may include various appropriate operations and may be based on various relevant factors (e.g., content identity, content type, original presentation parameters, optimized presentation parameters, user type, display device type, presentation app, etc.).

Based on the analysis, the process may update (at 450) the optimization algorithms associated with the analysis. For instance, the updates may affect the way(s) compression is applied, resolution is modified, frame rate is adjusted, etc.

The process may then update (at 460) the optimization parameters and then may end. Such updates may include, for instance, changes to a lookup table or other data structure that affects the attribute adjustment parameters based on allocated bandwidth.

In this way, crowd-sourced feedback may be utilized to identify the attributes and/or adjustments that are perceived as important or significant by many users. Such attributes and/or adjustments may be modified based on the feedback such that subsequent provision of media over the allocated bandwidth maximizes user satisfaction. The adjustments may include defining and/or modifying a set of parameters associated with the attributes.

The feedback may be applied in various appropriate ways (e.g., based on user type, device type, content type, etc.). In addition, the feedback may be associated with various different sets of users, content items, bandwidth allocation, etc. Thus, for instance, high definition video content delivered to a smartphone over a cellular network may be optimized using a first set of attributes and/or adjustments while low-definition streaming video provided over a wireless local network to a personal computer may be optimized using a second set of attributes and/or adjustments.

One of ordinary skill in the art will recognize that processes 300 and 400 may be implemented in various different ways without departing from the spirit of the invention. For instance, various operations may be omitted and/or other operations included. As another example, the operations may be performed in a different order than shown. In addition, some operations may be divided into multiple operations or multiple operations combined into a single operation. Each process may be divided into a set of sub-processes and/or be performed as part of a larger macro process. Each process, and/or portions thereof, may be performed iteratively based on some relevant criteria.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

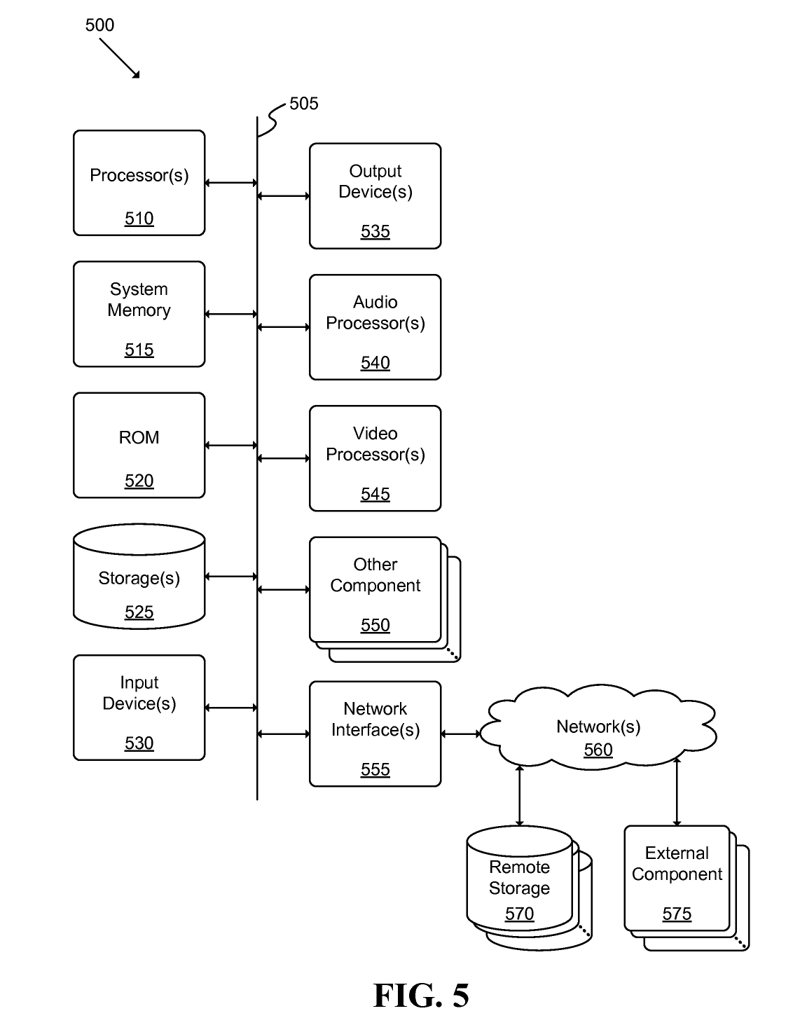

FIG. 5 illustrates a schematic block diagram of an exemplary computer system 500 used to implement some embodiments. For example, the systems described above in reference to FIGS. 1-2 may be at least partially implemented using computer system 500. As another example, the processes described in reference to FIGS. 3-4 may be at least partially implemented using sets of instructions that are executed using computer system 500.

Computer system 500 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 500 may include at least one communication bus 505, one or more processors 510, a system memory 515, a read-only memory (ROM) 520, permanent storage devices 525, input devices 530, output devices 535, audio processors 540, video processors 545, various other components 550, and one or more network interfaces 555.

Bus 505 represents all communication pathways among the elements of computer system 500. Such pathways may include wired, wireless, optical, and/or other appropriate communication pathways. For example, input devices 530 and/or output devices 535 may be coupled to the system 500 using a wireless connection protocol or system.

The processor 510 may, in order to execute the processes of some embodiments, retrieve instructions to execute and/or data to process from components such as system memory 515, ROM 520, and permanent storage device 525. Such instructions and data may be passed over bus 505.

System memory 515 may be a volatile read-and-write memory, such as a random access memory (RAM). The system memory may store some of the instructions and data that the processor uses at runtime. The sets of instructions and/or data used to implement some embodiments may be stored in the system memory 515, the permanent storage device 525, and/or the read-only memory 520. ROM 520 may store static data and instructions that may be used by processor 510 and/or other elements of the computer system.

Permanent storage device 525 may be a read-and-write memory device. The permanent storage device may be a non-volatile memory unit that stores instructions and data even when computer system 500 is off or unpowered. Computer system 500 may use a removable storage device and/or a remote storage device as the permanent storage device.

Input devices 530 may enable a user to communicate information to the computer system and/or manipulate various operations of the system. The input devices may include keyboards, cursor control devices, audio input devices and/or video input devices. Output devices 535 may include printers, displays, audio devices, etc. Some or all of the input and/or output devices may be wirelessly or optically connected to the computer system 500.

Audio processor 540 may process and/or generate audio data and/or instructions. The audio processor may be able to receive audio data from an input device 530 such as a microphone. The audio processor 540 may be able to provide audio data to output devices 540 such as a set of speakers. The audio data may include digital information and/or analog signals. The audio processor 540 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 545 (or graphics processing unit) may process and/or generate video data and/or instructions. The video processor may be able to receive video data from an input device 530 such as a camera. The video processor 545 may be able to provide video data to an output device 540 such as a display. The video data may include digital information and/or analog signals. The video processor 545 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 550 may perform various other functions including providing storage, interfacing with external systems or components, etc.

Finally, as shown in FIG. 5, computer system 500 may include one or more network interfaces 555 that are able to connect to one or more networks 560. For example, computer system 500 may be coupled to a web server on the Internet such that a web browser executing on computer system 500 may interact with the web server as a user interacts with an interface that operates in the web browser. Computer system 500 may be able to access one or more remote storages 570 and one or more external components 575 through the network interface 555 and network 560. The network interface(s) 555 may include one or more application programming interfaces (APIs) that may allow the computer system 500 to access remote systems and/or storages and also may allow remote systems and/or storages to access computer system 500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1-12. (canceled)

13. A method that adjusts content optimization based on user feedback, the method comprising:
providing a first content item to at least one destination device, said first content being optimized according to available bandwith;
receiving feedback from the at least one destination device;
analyzing the received feedback; and
updating at least one optimization parameter from among a set of optimization parameters based on the received feedback,
updating the content according to the updated at least one optimization parameter,
wherein the content optimizing comprises selecting at least one parameter among a set of optimization parameters and updating the content according to the selected at least one parameter.

14. The method of claim 13, wherein the set of optimization parameters comprises at least one of frame rate, resolution, bit rate, bit depth, and color depth.

15. The method of claim 13, wherein the feedback comprises a user satisfaction level.

16. The method of claim 13, wherein the feedback comprises crowd-sourced data associated with a plurality of destination devices and a plurality of optimized content items.

17. A server that adjusts content optimization based on user feedback, the server comprising:
a processor for executing sets of instructions; and
a non-transitory medium that stores the sets of instructions, wherein the sets of instructions comprises:
providing a first content item to at least one destination device, said first content being optimized according to available bandwith;
receiving feedback from the at least one destination device;
analyzing the received feedback; and
updating at least one optimization parameter from among a set of optimization parameters based on the received feedback,
updating the content according to the updated at least one optimization parameter,
wherein the content optimizing comprises selecting at least one parameter among a set of optimization parameters and updating the content according to the selected at least one parameter.

18. The server of claim 17, wherein the set of optimization parameters comprises at least one of frame rate, resolution, bit rate, bit depth, and color depth.

19. The server of claim 17, wherein the feedback comprises a user satisfaction level.

20. The server of claim 17, wherein the feedback comprises crowd-sourced data associated with a plurality of destination devices and a plurality of optimized content items.
